(19) United States
(12) Patent Application Publication
(10) Pub. No.: US 2005/0044560 A1
(43) Pub. Date: Feb. 24, 2005

(54) Methods, data structures, and systems for monitoring and integrating media streams

(75) Inventor: Arben Kryeziu, Wailuku, HI (US)

Correspondence Address: Schwegman, Lundberg, Woessner & Kluth, P.A., P.O. Box 2938, Minneapolis, MN, 55402, US

(73) Assignee: Maui X-tream, Inc.

(21) Appl. No.: 10/645,691

(22) Filed: Aug. 21, 2003

(51) Int. Cl. H04N 7/025; H04H 9/00; H04N 7/16; G06F 17/24; G06F 17/21

(52) U.S. Cl. 725/14; 725/1; 725/32; 725/135; 715/500.1; 715/501.1

(57) ABSTRACT

Methods, data structures, and systems monitor and integrate media streams. A media stream includes a self-installing and self-executing media player, media content, a purchasing system interface, and configuration monitoring information. The media stream is streamed to requesting recipients and once received by the recipients, the media player loads, configures itself, and executes on computing devices of the recipient. The media player simultaneously presents the media content and the purchasing system interface. The media player uses the configuration monitoring information to track interactions with the purchasing system interface and usage statistics associated with playing the media content. g

### TECHNICAL FIELD

Embodiments of the present invention relate generally to media streaming, and more particularly to monitoring and integrating media streams.

### BACKGROUND INFORMATION

Network transmission of media streams has become commonplace in today's electronic economy. Individuals now consume media streams to video conference, watch television, watch movies, listen to radio, transmit personal videos, and talk with one another.

The pervasiveness of media streams has created a number of business opportunities for content providers. For example, now media content associated with media streams does not need to be physically packaged on computer media (e.g., Compact Disks (CDs), Digital Versatile Disks (DVDs)). Now content providers can package and deliver their media content nearly instantaneously over the Internet directly to a consumer.

However, the content providers have still not been able to fully take advantage of streaming technology to get a firm understanding of how consumers consume or use their media content. Furthermore, content providers have not created easy integrated purchasing systems with their media content, such that when on-line purchases are made each transaction can be effectively tracked for purposes of running their business. For example, typically content providers largely track electronic accesses (hits) for their media content and are ineffective at actually tracking purchases occurring through their vendors. Purchasing information is valuable information, which if effectively trapped and recorded could permit content providers to more accurately pay sales commissions and better plan advertising and marketing budgets for their media content.

Therefore, there is a need for improved monitoring and integration techniques for media streams. These implementations should be capable of more effectively monitoring and reporting purchasing usage statistics associated with consumers buying and playing the media content. Further, these implementations should be capable or more effectively integrating media content with the presentation and automatic interaction of purchasing system interfaces.

### BRIEF DESCRIPTION OF THE DRAWINGS

FIG. 1 is a flow diagram of a method for monitoring and integrating media streams, in accordance with one embodiment of the invention.

FIG. 2 is a diagram depicting a media stream data structure, in accordance with one embodiment of the invention.

FIG. 3 is a diagram of a media stream monitoring and integration system, in accordance with one embodiment of the invention.

### SUMMARY OF THE INVENTION

In various embodiments of the present invention, techniques for monitoring and integrating media streams are taught. A media stream includes a self-installing and self-executing media player and media content, media content, a purchasing system interface, and other configuration monitoring information. The media player configures a media stream interface that simultaneously presents the media content along with the purchasing system interface. Additionally, the media player monitors interactions with the purchasing system interface and records other usage statistics associated with playing the media content.

More specifically and in one embodiment of the invention, a method for monitoring and integrating media streams is described. A purchasing system interface is selected for use with a media stream. The media stream is packaged with a self loading and self executing media player and with configuration information for presenting the purchasing system interface with the media stream and monitoring usage of the media stream. Next, the media is streamed to a recipient.

### DESCRIPTION OF THE EMBODIMENTS

Novel methods, data structures, and systems for monitoring and integrating media stream usage are taught. In the following detailed description of the embodiments, reference is made to the accompanying drawings, which form a part hereof, and in which is shown by way of illustration, but not limitation, specific embodiments of the invention that may be practiced. These embodiments are described in sufficient detail to enable one of ordinary skill in the art to understand and implement them, and it is to be understood that other embodiments may be utilized and that structural, logical, and electrical changes may be made without departing from the spirit and scope of the present disclosure. The following detailed description is, therefore, not to be taken in a limiting sense, and the scope of the embodiments of the inventions disclosed herein is defined only by the appended claims.

As used herein the phrase “media stream” includes media content/data that is related to multimedia such as, by way of example only, audio, video, graphical, image, text, and combinations of the same. Media streams of this invention also include a self-installing and self-executing media player, such as the one described in U.S. patent application Ser. No.: 10/369,017, entitled: “Methods, Data Structures, and Systems for Processing Media Data Streams,” filed on Feb. 19, 2003, the disclosure of which is hereby incorporated by reference.

The media streams can be streamed using conventional transferring techniques, such as by breaking media stream up into configurable byte chunks, blocks, or frames and serially transmitting these pieces over a network to a one or more recipients' computing devices. The network can be hardwired (e.g., direct (point-to-point), indirect (e.g., Wide Area Network (WAN), such as the Internet), and others). The network can also be wireless (e.g., Infrared, Radio Frequency (RF), Satellite, Cellular, and others). Furthermore, the network can be a combination of hardwired and wireless networks interfaced together.

A content provider is an entity that is authorized to electronically distribute the media content of the media stream. Thus, content provider may be an entity that originally creates the media content for direct electronic distribution, or the content provider may be an entity that acquires a license to distribute the media content. The content provider can also be represented as one or more electronic applications or services within a computer-accessible medium over a network.

Moreover, a content provider can be an owner, a vendor, a distributor, or a licensee having some legal rights to the media content. Again, the owner, vendor, distributor, or licensee can be any entity that physically interfaces with other electronic interfaces to achieve the teachings of this invention. Alternatively, the content provider can be one or more automated applications representing physical entities and processing with other electronic interfaces of this invention.

In a like manner the use of the term “recipient,” can be a physical entity interacting with other electronic interfaces or an automated application interfacing with the electronic interfaces. A recipient can also be used herein synonymously with “consumer.” Moreover, the designation of the term “recipient” is dependent upon processing states of the techniques presented with this invention. Thus, a recipient in some instances can be a down stream licensee, distributor, content provider, or vendor of the media content.

The phrase “purchasing system interface” includes any conventionally available electronic interface used for purchasing goods or services over a network. Alternatively, the purchasing system interface can be a custom-developed or ad hoc electronic interface developed for purposes of integrating with the teachings of this invention. Thus, in one embodiment, a purchasing system interface is implemented as one or more World-Wide Web (WWW) browser pages using any conventionally available browser-enabled data format (e.g., Hypertext Markup Language (HTML), Extensible Markup Language (XML), Extensible Style Sheets Language (XSL), and others). These browser pages may be already capable of processing within frames of a browser or can be slightly modified to be frame-enabled for purposes of various embodiments of this invention. Additionally, these browser pages can directly interact with native processing on a purchasing system's WWW server or portal. Further, these browser pages can include a variety of embedded systems or applications for processing payment information that is independent and distinct from the purchasing system interfaces, such as credit card payment services or portals.

The media stream of embodiments of this invention includes the self-loading and executing media player, media content, and a media stream interface. The media player instantiates specific instances of the media stream interface for a specific recipient based on configuration information included within the media stream. The configuration information includes references or links to a desired purchasing system interface and a variety of other information that the media player uses to configure a specific customized media stream interface for a particular recipient. The other configuration information can include media player processing directives for selectively capturing and monitoring interactions occurring between a recipient and the purchasing system interface or for selectively monitoring, tracking or reporting recipient usage statistics associated with playing the media content. Additionally, the other configuration information can include customized advertisement information or links that the media player uses when configuring and creating a specific media stream interface for a particular recipient.

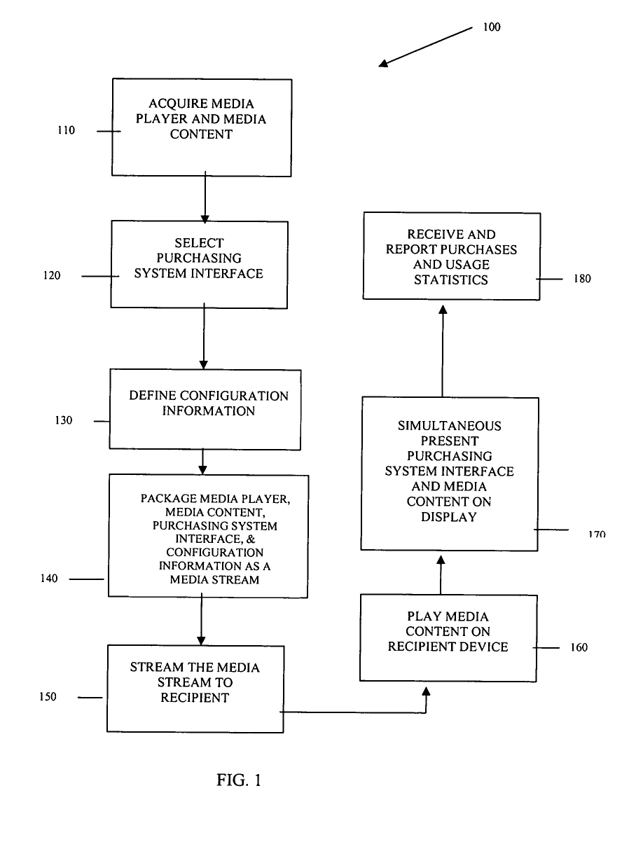

FIG. 1 depicts a flow diagram of one method 100 for monitoring and integrating media streams, in accordance with one embodiment of the invention. The processing of the method 100 is implemented in one or more computer-accessible media. Furthermore, in one embodiment, the processing is a remote packaging or distribution service accessible over a network (e.g., Internet) to one or more requesting recipients. The recipients can be consumers that desire media content for consumption or other services that desire to further distribute the media content to downstream recipients over a network. Each recipient includes a computing device and a display for viewing the media content.

At 110, a self-installing and self-executing media player and media content are acquired. One self-installing and self-executing media player can be as defined in U.S. patent application Ser. No.: 10/369,017, entitled: “Methods, Data Structures, and Systems for Processing Media Data Streams,” filed on Feb. 19, 2003. Media content includes video or animation provided by a content provider in an electronic format for distribution over a network to recipients.

The media player and media content are acquired from one or more electronic data stores or external services based on a specific request for the media content made by a recipient. The recipient can request the media content, in some embodiments, by accessing options of a television service interfaced to a network having access to the processing of the method 100. Alternatively, the recipient can request the media content, in other embodiments, by using a computing device to make a selection for the media content, where the computing device is interfaced to the processing of the method 100 over a network (e.g., accessing a hypertext link within a WWW browser connected to the Internet).

Next, at 120, a purchasing system interface is selected for use with the media player and the media content. This selection can be made directly by a recipient requesting the media content or made in a predetermined manner by the processing of the method 100. When a recipient identifies the purchasing system interface, then this identification can be made via a manual selection of available purchasing system interfaces provided by the processing of the method 100. Alternatively, the processing of the method 100 can automatically determine a particular recipient's desired purchasing system interface based on previously retained recipient preferences or by accessing preferences retained on the recipient's computing device (e.g., accessing WWW cookies on the recipient's computing device).

When the processing of the method 100 determines the appropriate purchasing system interface, the technique implemented for purchasing system interface determination can be made using a variety of techniques. For example, computing environment attributes (e.g., browser type, browser version, and others) can be automatically acquired from the recipient and used to select a proper purchasing system interface. Other techniques can be used as well with the embodiments of this invention and are intended to fall within the scope of this disclosure.

The purchasing system interface can be references or links to other external applications or services available over a network or can be a self-contained and self-executing set of applications included with the media content and media player for processing purchases over a network. The purchasing system interface permits interacting with a service that permits media content to be purchased by a consumer. Thus, the purchasing system interface can be maintained directly by a content provider, a distributor, a licensee, or a vendor. Moreover, the purchasing system interface can be an external service that is used by these entities to process purchase orders for media content on-line. A variety of existing and well known WWW purchasing system portal services and interfaces are available within the industry, all such interfaces are intended to fall within the scope of this invention.

At 130, other configuration information is defined within the processing of the method 100. This configuration information can include processing directives for the media player that directs the media player to capture, monitor, and report a variety of purchasing interactions and usage statistics associated with the media content. The configuration information can be predefined within the processing of the method 100 or defined by a content provider, licensee, vendor, or distributor. The retention of the configuration information can reside on a content provider, licensee, vendor, or distributor's computing environment; can reside within the computing environment of the processing for the method 100; or can reside as hidden files or cookies within the computing environment of the recipient.

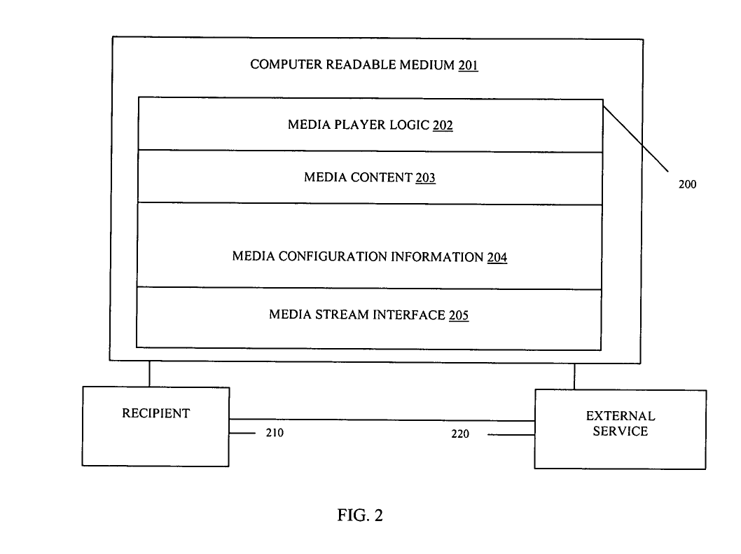

At 140, once the processing of the method 100 has the proper media player, media content, purchasing system interface, and other configuration information, this information is packaged together as a single media stream. This media stream can be implemented, in some embodiments, as a single media stream data structure, as is defined further below with the discussion of FIG. 2. Alternatively, the media stream can be a series of files all logically associated with one another and known to the media player. The ordering of the various components within the media stream is not significant, since the media player can be implemented to proper acquire each component when needed.

At 150, the processing of the method 100 streams the packaged media stream to the recipient, who originally made a request for the media content. Any conventional streaming technique or ad-hoc streaming technique can be used with the embodiments depicted in FIG. 1. In fact, in some embodiments, streaming simply refers to transmitting the media stream; such that any technique used to transmit data (e.g., email, and other) can be used to transmit the media stream to a recipient.

Once the media stream is completely received or partially received (where at least the media player is fully received) on the recipient's computing device, the media player self-installs and executes itself on the recipient's computing device. As part of an initialization process, the media player will configure itself for proper execution on the recipient's computing device. This initialization process includes using the configuration information included within the media stream to create a media stream interface on the recipient's computing device.

The media stream interface includes a simultaneous presentation, within a display communicating with the recipient's computing device, of the media content and the selected purchasing system interface. One technique for doing this and providing the proper integration of the media player and the purchasing system interface is through the use of browser frames. Thus, in one embodiment, at least two browser frames are in communication and displayed within a recipient's browser. The first frame is an area for playing the media content, and the second frame is an area for interacting or directly accessing selections of the purchasing system's interface. Thus, the media player creates the media stream interface and it is capable or monitoring and reporting interactions occurring with the purchasing system interface and the media content.

In some embodiments, the configuration information used by the media player to create the media stream interface can also include advertisement information. The advertisement information can be customized based on preferences of the advertiser or based on preferences or usage information associated with the recipient. The advertisement information can, in some embodiments, also be simultaneously presented within the media stream interface as a third frame. Alternatively, the advertisement information can be non interactive within the media stream interface or enabled to fork off a separate and distinct browser that is linked to an advertiser when the advertisement information is selected by the recipient.

Once the media player properly instantiates and configures the media stream interface, the media stream interface is presented to the recipient for interaction. Accordingly, at 160, when a proper selection within the media stream interface is made by the recipient, the media player initiates play of the media content within the media stream interface. At 170, both the purchasing system interface and the media content being played are simultaneously presented within the recipient's display. Moreover, both the media content and the purchasing system interface can be independently interfaced to by the recipient within the media stream interface.

If the recipient decides that he/she desires to purchase a complete version of the media content (e.g., the original provided media content may be a trailer to a movie used to entice a purchase of that movie), then he/she makes a proper selection within the media stream interface to select a payment option included within the purchasing system's interface. This transaction is captured by the media player that is controlling the media stream interface (e.g., via framing technology).

Thus, at 180, the purchase transaction is received by the processing of the method 100 from the media player. The processing of the method 100 can use this information to notify a content provider, licensee, distributor, or vendor associated with the media content of the purchase.

Moreover, the purchase can include other useful information that is tracked and reported by the media player. For example, the media player can track and report a purchasing system interface identifier, a time of purchase, a recipient identity, and a paid purchase price.

Some of this additional information may prove useful to the content provider, licensee, distributor, or vendor, such as when a commission is due to the entity associated with the purchasing system interface. The commission can be paid based on the purchase price and automatically acquired by the purchasing system interface entity during the purchase. For example, the purchase price paid is $20 and the actual price of the media content for the purchase system interface entity is $15. In this example, the purchasing system interface entity acquires an automatic commission of $5 when a purchase for the media content is made. Alternatively, the commission can be paid on a periodic bases using purchasing information assembled and reported to the content provider, licensee, distributor, or vendor. The purchase information assembling and reporting processes can be also done by services associated with a service implementing the processing of the method 100.

Furthermore, the purchasing system interface entity can also be a licensee, distributor, or vendor of the media content. Additionally, more than one entity can be involved in any single purchase transaction, such that multiple entities collect commissions for that transaction. Thus, a service implementing the processing of the method 100 can also collect a transaction or commission for any particular purchase.

Other useful usage statistics can also be monitored and reported by the media player back to the processing of the method 100 or back to other identified entities (e.g., content provider, licensee, distributor, or vendor). For example, it may be useful to track how much of the media content was actually played by the recipient, when (day and time of day) the recipient played the media content, and if any problems were experienced during play of the media content.

Thus, at 180, the processing of the method 100 receives, and in some instances, reports purchase and usage statistics to interested entities. These statistics can be useful in properly recording and paying commissions or transaction fees and may be useful in establishing budgets and planning associated with an entity's on-line media content business.

Conventionally, interested entities have relied on on-line hit reports that describe a raw number of visits to a site that plays their media content. This reliance has not proved very useful to these entities and is not detailed enough for these entities to effectively run their on-line media content businesses. With embodiments of this invention, interested entities can now acquire detailed purchasing information and usage information that adequately depicts how and where their media content is being purchased and used. This is valuable information which effectively permits interested entities to leverage the on-line environment to its maximum potential by developing more accurate fee policies and by using the most productive on-line distribution outlets.

FIG. 2 is a diagram depicting one media stream data structure 200, in accordance with one embodiment of the invention. The media stream data structure 200 resides in a computer-accessible medium 201 and can be consumed over a network by a variety of application or services interested in monitoring media content usage and purchase transactions. Furthermore, the processing of the method 100 can be used to generate an initial and specific customized instance of the media stream data structure 200.

The media stream data structure 200 includes media player logic 202, media content 203, media configuration information 204, and a media stream interface 205. The media player logic 202 is a self-installing and self-executing software application or application(s). Thus, when at least all of the data associated with the media player logic 202 is received by a recipient 210, the media player logic 202 self-installs and executes itself on the recipient's 210 computing device.

The media player logic 202 is implemented to use the media configuration information 204 in order to instantiate a specific customized instance of the media stream interface 205. In some embodiments, in doing this configuration, the media player logic 202 also uses computing environment attributes that it acquires from the recipient's 210 computing device, such as browser type, browser version, and the like.

The media content 202 is a video or animation originating from a content provider. In some embodiments, the media content is a movie trailer or snippet used to entice the recipient 210 to purchase a complete version of a movie. The media configuration information 204 includes links to or a self contained purchasing system interface. In one embodiment, the media configuration information 204 can also include advertisements. Further, the media configuration information 204 includes processing directives for the media player logic 202. These processing directives define what types of information that the media player logic 202 is to monitor and report back to an external service 220 (such as the one depicted in FIG. 1), content provider, licensee, distributor, and/or vendor. Types of information include, by way of example only, a unique identifier for an entity associated with the purchasing system interface, a purchase price received by the purchasing system interface, price paid for a purchase, date and time of a purchase, a unique identifier for the media content 203, a unique identifier for the recipient 210, amount of media content 203 actually viewed by the recipient 210, day and time media content 203 was viewed by the recipient 210, any errors that occurred while viewing the media content 203, and other types of information.

The media player logic 202 uses the media configuration information to establish a specific configurable instance of the media stream interface 205. The media stream interface 205 integrates the purchasing system interface, any advertisements, and the media content 203 into a single presentable interface 205. In one embodiment, this media stream interface 205 is implemented in a browser as a series of links and browser pages having multiple frames, where one frame includes an area for playing the media content 203 and another frame includes links for interacting with the purchasing system interface.

Moreover, the media player logic 202 uses the processing directives of the media configuration information 204 to monitor and report interactions occurring with the media stream interface 205. Thus, when a recipient 210 plays the media content 203 within the media stream interface 205, the media player logic records a number of usage statistics associated with this play.

Additionally, when the recipient 210 makes a purchase selection from the purchasing system interface within the media stream interface, the media player logic 202 records or monitors this transaction. If that selection results in an actual purchase of a complete version of the media content 203, then this particular transaction is also captured by the media player logic 202.

Therefore, as was described in detail above with FIG. 1, the media stream data structure 200 can be used to capture specific purchases occurring with a specific recipient. These purchases are then reported back to an interested external service 220, either dynamically, or on a configurable periodic basis by the media player logic 202. These purchases are also associated with useful purchasing information that can be used by the external service 220 to pay or collect transactions and/or commissions from interested entities.

Additionally, the captured usage statistics can be assembled on a configurable basis or dynamically reported to the external service 220 by the media player logic 220. Thus, the usage statistics and the purchasing information can be used by interested entities to properly allocate resources and manage their media content businesses.

Although, embodiments of FIG. 2 have been discussed such that the media player logic 202 monitors and reports purchasing information and usage statistics, this need not be the case in every embodiment of this invention. For example, the media stream interface 205 can monitor and track this information. Alternatively, the media player logic 202 can include a variety of independent applications, some of which monitor and report the information and some of which are designed to play the media content 203. Also, in some embodiments, the media player logic 202 can be used after it installs on the recipient's 210 computing device to communicate with the external service 220 for purposes of acquiring specific values for the media configuration information 204 and the media stream interface 205 needed to fully populate an instance of the media stream data structure 200.

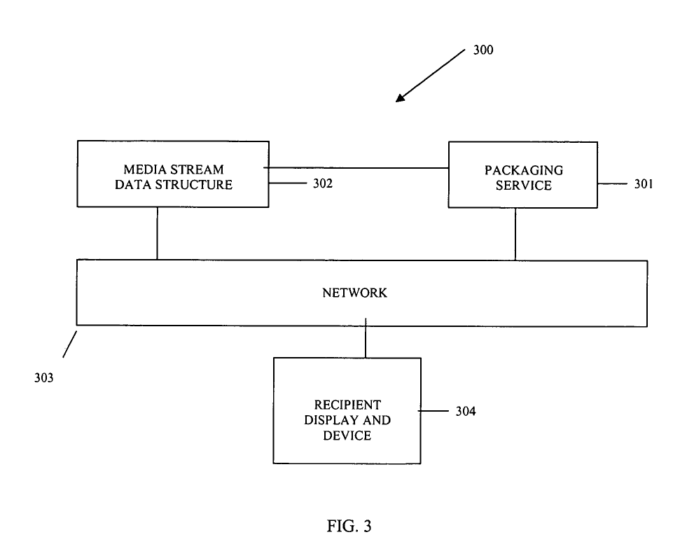

FIG. 3 is a diagram of one media stream monitoring and integration system 300, in accordance with one embodiment of the invention. The media stream monitoring and integration system 300 is enabled to process the method 100 of FIG. 1 in order to package, monitor, and distribute the media stream data structure 200 of FIG. 2. Additionally, the media stream monitoring and integration system 300 is implemented in one or more computer-accessible media and accessible for operation over a network 303.

The media stream monitoring and integration system 300 includes a media stream data structure 302, a packing service 301, a network 303, and a display 304 associated with a recipient's computing device.

The packaging service 301 creates and distributes instances of the media stream data structure 302 over the network to a display 304 of a requesting recipient that desires media content. The media stream data structure 302 includes the desired media content and further includes a self-installing and self-executing media player. Additionally, the media stream data structure 302 includes configuration information.

The configuration information includes a purchasing system interface (or links thereto), optionally customized advertisement information, and processing directives used by the media player to, present, monitor, and report interactions with the purchasing system interface and the media content.

The media player simultaneously presents within the display 304 the purchasing system interface and portions of the media content for consumption and interactions made by a requesting recipient. When the recipient interacts with the purchasing system to make purchases, these transactions are captured by the media player and reported back to the packaging service 301, or other interested services or entities. In a like manner, as the recipient plays various portions of the media content usage statistics are gathered and reported back to the packaging service 301 or other interested services or entities. These reporting or notifying events are made by the media player to the appropriate service or entity over the network 303.

It is now apparent, how interested entities can track and monitor purchasing and usage statistics associated with their media content. The embodiments of this invention permit more intelligent and effective use of on-line technologies used for distributing, packaging, and monitoring media content over a network.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Description of the Embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method for monitoring and integrating media streams, comprising:
selecting a purchasing system interface for use with a media stream;
packaging the media stream with a self loading and self executing media player and with configuration information for presenting the purchasing system interface with the media stream and monitoring usage of the media stream and purchasing system interface; and
streaming the media stream to a recipient.

2. The method of claim 1 further comprising playing a portion of the media stream on a computing device of the recipient by using the media player, wherein media content included within the media stream is simultaneously presented on a display with the purchasing system interface and the purchasing system interface can be independently interacted with via the display.

3. The method of claim 2 further comprising receiving purchasing selections from the recipient accessing a number of options from the purchasing system interface while viewing portions of the media content and using the media player for tracking any purchase that occurs for the media content.

4. The method of claim 3 wherein receiving purchasing selections further includes notifying or recording the purchase for purposes of paying a commission or establishing a budget.

5. The method of claim 4 wherein playing further includes:
presenting the media content within a first frame of a browser page; and
presenting the purchasing system interface within a second frame of the browser page.

6. The method of claim 1 further comprises receiving usage statistics from the media player identifying playing and purchasing information associated with the recipient playing media content included within the media stream and interacting with the purchasing system interface.

7. The method of claim 1 wherein packaging further comprises including customized advertisement information with the media stream.

8. A media stream structure residing on a computer readable medium, for monitoring and integrating media streams, the data structure comprising:
media player logic;
media content; and
media configuration information;
wherein when the media stream data structure is received by a computing device, the media player logic automatically installs itself on the computing device, executes, and configures a media stream interface using the media configuration information, wherein the media stream interface includes a purchasing system interface for purchasing the media content and a media playing interface for playing the media content.

9. The media stream data structure of claim 8 wherein the configuration information also includes monitoring information used by the media player logic to track usage of the media content.

10. The media stream data structure of claim 8 wherein the configuration information also includes advertisement information that is used by the media player logic to present and make accessible a variety of customized advertisements.

11. The media stream data structure of claim 8 wherein the media stream interface interacts with the media player logic to communicate purchasing interactions made through the purchasing system interface to at least one of a remote service, a licensor, an owner, and a vendor of the media content.

12. The media stream data structure of claim 8 wherein the media stream interface is a browser interface accessible over a network.

13. The media stream data structure of claim 12 wherein the browser interface includes one or more World-Wide Web browser pages and the network is the Internet.

14. The media stream data structure of claim 8 wherein the media stream data structure is packaged by an external service and streamed to a requesting recipient over a network.

15. A media stream monitoring and integration system, comprising:
a media stream data structure having a self loading and executing media player, a purchasing system interface, and monitoring configuration information; and
a display;
wherein the media player simultaneously presents within the display media content included within the media stream data structure and the purchasing system interface, and wherein the media player tracks purchases and usage statistics associated with purchasing and playing the media content based on the monitoring configuration information.

16. The media stream monitoring and integration system of claim 15 wherein the configuration information also includes advertisement information that the media player uses to also simultaneously present within the display a variety of customized advertisements.

17. The media stream monitoring and integration system of claim 15 wherein at least one of a vendor, an owner, and a licensee packages the media stream data structure with the purchasing system interface and the media content.

18. The media stream monitoring and integration system of claim 15 wherein the media stream data structure is streamed from a remote service to a requesting recipient's computing device that is interfaced to the display.

19. The media stream monitoring and integration system of claim 15 wherein the media player captures interactions made with the purchasing system interface and reports these interactions back to at least one of a remote service, a vendor, an owner, and a licensee of the media content.

20. The media stream monitoring and integration system of claim 15 wherein the media player or a remote service periodically assembles the purchasing and usage statistics into an electronic report and sends the report to at least one of a vendor, an owner, and a licensee of the media content.
